(19) United States
(12) Patent Application Publication
(10) Pub. No.: US 2016/0289109 A1
(43) Pub. Date: Oct. 6, 2016

(54) ENHANCED TREATMENT SHAFT

(71) Applicant: Saad A. GHALIB, Ann Arbor, MI (US)

(72) Inventor: Saad A. GHALIB, Ann Arbor, MI (US)

(21) Appl. No.: 15/037,820

(22) PCT Filed: Nov. 21, 2014
(86) PCT No.: PCT/US2014/066930

§ 371 Date: May 19, 2016

Related U.S. Application Data
(60) Provisional application No. 61/907,591, filed on Nov. 22, 2013.

(51) Int. Cl. C02F 9/00; C02F 1/56; C02F 1/74; B01D 21/01; C02F 1/76; C02F 1/72; C02F 3/26; C02F 1/52; C02F 1/78

(52) U.S. Cl. CPC C02F 9/00; C02F 1/5245; C02F 1/56; C02F 1/74; C02F 1/78; C02F 1/76; C02F 1/722; C02F 3/26; B01D 21/01; C02F 2103/001

(57) ABSTRACT

A wastewater treatment system for treating wastewater includes one or more containers that each include first and second portions. The treatment system further includes a first treating agent system for introducing a coagulation agent and/or flocculation agent into the wastewater, a second treating agent system for introducing a biological activity facilitating agent into the wastewater, and a third treating agent system for introducing a disinfection agent into the wastewater. Each container is configured to allow the wastewater to flow through the corresponding first and second portions. The first treating agent system is operable to introduce the coagulation agent and/or flocculation agent into the wastewater to facilitate clumping of suspended particles, the second treating agent system is operable to introduce the biological activity facilitating agent into the wastewater to enhance biological treatment of the wastewater, and the third treating agent system is operable to introduce the disinfection agent into the wastewater.

### CROSS-REFERENCE TO RELATED APPLICATION

This application claims the benefit of U.S. provisional application Ser. No. 61/907,591 filed Nov. 22, 2013, the disclosure of which is hereby incorporated in its entirety by reference herein.

### TECHNICAL FIELD

The disclosure relates to systems and methods for treating wastewater from a sewer system, such as a combined sewer system or a sanitary sewer system.

### BACKGROUND

Conventional waste water treatment plants are expensive to build and may be beyond available local resources for small to medium size cities, especially for developing countries. Such treatment plants also require large land areas, which may involve significant real estate costs. Furthermore, such treatment plants are costly to maintain and require skilled operational staff that may not be readily available.

Another waste water treatment system involves use of a shaft structure. Examples of such a system are disclosed in U.S. Pat. No. 6,503,404.

### SUMMARY

According to one aspect of the disclosure, a wastewater treatment system for treating wastewater is provided. The treatment system includes one or more containers that each include first and second portions that each have an upper end and a lower end, wherein, for each container, the corresponding lower ends are interconnected. The treatment system further includes a first treating agent system for introducing a coagulation agent and/or flocculation agent into the wastewater, a second treating agent system for introducing a biological activity facilitating agent into the wastewater, and a third treating agent system for introducing a disinfection agent into the wastewater. Each container is configured to allow the wastewater to flow through the corresponding first and second portions such that the wastewater is able to flow generally in a first direction through the corresponding first portion, then generally in a second direction different than the first direction through the corresponding second portion. The first treating agent system is operable to introduce the coagulation agent and/or flocculation agent into the wastewater to facilitate clumping of suspended particles, the second treating agent system is operable to introduce the biological activity facilitating agent into the wastewater to enhance biological treatment of the wastewater, and the third treating agent system is operable to introduce the disinfection agent such that the disinfection agent has sufficient contact time with the wastewater to at least partially disinfect the wastewater after sufficient biological treatment of the wastewater.

According to another aspect of the disclosure, a wastewater treatment system for treating wastewater from a sewer system is provided. The treatment system includes a first vertically oriented shaft structure configured to receive wastewater from the sewer system, a second vertically oriented shaft structure connected in series with the first shaft structure and configured to receive wastewater from the first shaft structure, and a third vertically oriented shaft structure connected in series with the second shaft structure and configured to receive wastewater from the second shaft structure. Each shaft structure has first and second portions that each have an upper end and a lower end, and, for each shaft structure, the lower ends are interconnected. The treatment system further includes a first treating agent system for introducing a coagulation agent and/or flocculation agent into the wastewater, a second treating agent system for introducing a gas into the wastewater, and a third treating agent system for introducing a disinfection agent into the wastewater. The system is configured to allow the wastewater to flow into the upper end of the first shaft structure first portion, through the first shaft structure first and second portions, then into the upper end of the second shaft structure first portion, through the second shaft structure first and second portions, then into the upper end of the third shaft structure first portion, and through the third shaft structure first and second portions, such that, for each of the first, second and third shaft structures, the wastewater is able to flow generally downward through the corresponding first portion, then generally upward through the corresponding second portion. The first treating agent system is operable to introduce the coagulation agent and/or flocculation agent into the wastewater to facilitate clumping of suspended particles, the second treating agent system is operable to introduce the gas into the wastewater in the first and/or second shaft structures to enhance biological treatment of the wastewater, and the third treating agent system is operable to introduce the disinfection agent such that the disinfection agent has sufficient contact time with the wastewater in the third shaft structure to at least partially disinfect the wastewater.

A method for treating wastewater from a sewer system is also provided. The method includes receiving the wastewater from the sewer system in a first portion of a first container, wherein the first container further includes a second portion, each portion has an upper end and a lower end, and the lower ends are interconnected. The method further includes allowing the wastewater to flow generally in a first direction through the first portion, and then generally in a second direction through the second portion, wherein the second direction is different than the first direction. In addition, the method includes introducing a coagulation agent and/or flocculation agent into the wastewater to facilitate clumping of suspended particles, introducing a biological activity facilitating agent into the wastewater to enhance biological treatment of the wastewater, and introducing a disinfection agent into the wastewater such that the disinfection agent has sufficient contact time with the wastewater to at least partially disinfect the wastewater after sufficient biological treatment of the wastewater.

While exemplary embodiments are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a top view of a treatment system according to the present disclosure showing three containers connected in series;

FIG. 2 is a cross-sectional view of the treatment system of FIG. 1 taken along line 2-2 of FIG. 1, and viewed in the direction of the arrows, wherein FIG. 2 shows first, second and third treating agent introduction systems associated with the containers;

FIG. 3 is a schematic cross-sectional view of the treatment system of FIGS. 1 and 2 showing the containers separated in order to show additional components of the treatment system, including a solids removal system associated with the containers;

FIG. 4 is an enlarged view of a portion of the treatment system showing an example embodiment of the first treating agent introduction system;

FIG. 5 is an enlarged view of another portion of the treatment system showing an example embodiment of the third treating agent introduction system;

FIG. 6 is a top view of a second embodiment of a treatment system according to the present disclosure showing three containers connected in series;

FIG. 7 is a cross-sectional view of the treatment system of FIG. 6 taken along line 7-7 of FIG. 6, and viewed in the direction of the arrows;

FIG. 8 is a top view of a third embodiment of a treatment system according to the present disclosure showing three containers connected in series; and

FIG. 9 is a cross-sectional view of the treatment system of FIG. 8 taken along line 9-9 of FIG. 8, and viewed in the direction of the arrows;

### DETAILED DESCRIPTION

As required, detailed embodiments are disclosed herein; however, it is to be understood that the disclosed embodiments are merely exemplary and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

The following disclosure provides various systems and methods for treating wastewater from a sewer system, such as a sanitary sewer system or a combined sewer system that is designed to carry both sanitary sewage and storm water runoff. The term “wastewater” as used in the application refers to sanitary sewage and/or storm water runoff. As explained below, the systems and methods provide improved treatment compared to other systems and methods for treating wastewater.

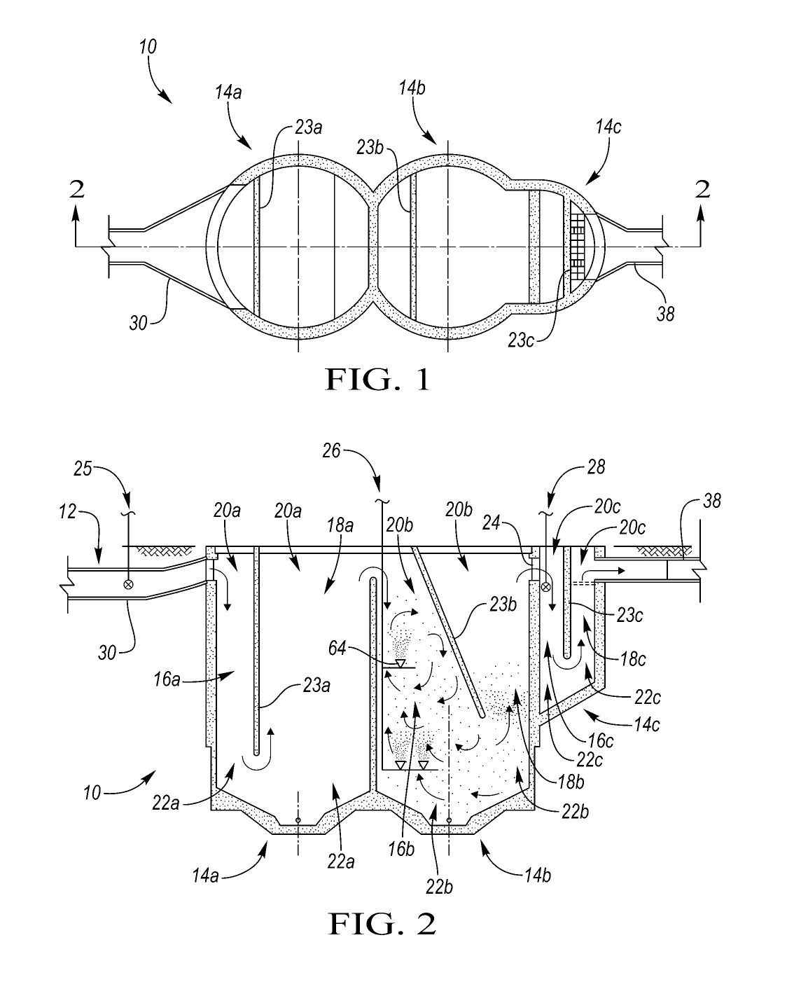

FIGS. 1-3 show a wastewater treatment system 10 according to the disclosure for treating excess wastewater from a sewer system 12. As mentioned above, the sewer system 12 may be a sanitary sewer system or a combined sewer system that is designed to carry both sanitary sewage and storm water runoff, for example. The treatment system 10 includes one or more containers 14 for receiving the wastewater, and each container 14 includes first and second portions 16 and 18, respectively, that each have an upper end 20 and a lower end 22. Furthermore, for each container 14, the corresponding lower ends 22 are interconnected.

In the embodiment shown in FIGS. 1-3, the treatment system 10 includes first, second and third containers, such as first, second and third shafts or shaft structures 14a, 14b and 14c, respectively, that are connected in series and that form a container arrangement or shaft arrangement. The treatment system 10 is configured to provide successive treatment of the wastewater as the wastewater flows through the shaft structures 14a, 14b, 14c, as explained below in detail. For example, in the embodiment shown in FIGS. 1-3, the treatment system 10 is configured to provide suspended solids removal in the first shaft structure 14a, biological treatment of the wastewater in the second shaft structure 14b, and disinfection of the wastewater in the third shaft structure 14c.

The first shaft structure 14a is configured to receive wastewater from the sewer system 12, and includes first and second portions (e.g., passages) 16a and 18a, respectively, that are separated by a divider 23a, such as a baffle wall. Furthermore, the portions 16a and 18a each have an upper end 20a and a lower end 22a, and the lower ends 22a are interconnected.

The second shaft structure 14b is connected in series with the first shaft structure 14a and is configured to receive wastewater from the first shaft structure 14a. The second shaft structure 14b has first and second portions (e.g., passages) 16b and 18b, respectively, that are separated by a divider 23b, such as a baffle wall. Furthermore, each of the portions 16b and 18b has an upper end 20b and a lower end 22b, and the lower ends 22b are interconnected.

In the embodiment shown in FIG. 2, the second shaft structure 14b may be supplied with biomass or microorganisms (e.g., bacteria augmentation) to accelerate system startup or enhance performance of the biological treatment process. Such microorganisms may be free swimming or attached to a suitable carrier or medium (e.g., rock, sponge, plastic, ceramic, metal, etc.). For example, the second shaft structure 14b may be provided with activated sludge that is a mixture of bacteria and other microorganisms. In addition, or as an alternative, microorganisms may be provided in or on multiple carrier elements (e.g., fixed media filters or biofilms), which may or may not be floatable within the second shaft structure 14b. As a more detailed example, each carrier element may be a round (e.g., spherical) or tubular element made of ceramic or plastic and having one or more openings, such as slots, grooves or channels, in which microorganisms are fixed or otherwise disposed. Suitable carrier elements are available from Saint-Gobain NorPro of Stow, Ohio, for example.

Addition of microorganisms may not be required, but may expedite bacteria growth in the second shaft structure 14b. In that regard, the wastewater itself may contain sufficient amounts of bacteria to sufficiently populate the second shaft structure 14b over time.

The treatment system 10 may further include one or more permeable barriers or separators, such as membranes, for retaining the activated sludge or fixed media in the second shaft structure 14b. In the embodiment shown in FIG. 2, for example, a separator or membrane 24 is positioned between the second shaft structure 14b and the third shaft structure 14c (e.g., positioned downstream of the second shaft structure 14b). The membrane 24 is configured to allow wastewater to pass therethrough, while inhibiting or preventing passage of the activated sludge or fixed media.

In another embodiment, the membrane 24 may be positioned in the second shaft structure 14b. For example, the membrane 24 may be positioned at the upper end 20b of the second portion 18b of the second shaft structure 14b, and extend horizontally such that the membrane 24 partially or entirely covers the horizontal cross-section of the second portion 18b beneath the connection location between the second and third shaft structures 14b and 14c. In yet another embodiment, the treatment system 10 may be provided with multiple membranes that are spaced apart in the second shaft structure 14b for dividing the second shaft structure 14b into multiple treatment zones. Each membrane may be made of any suitable material, such as polyvinylidene flouride. Example membranes are available from GE Power & Water of Trevose, Pa.

The third shaft structure 14c is connected in series with the second shaft structure 14b and is configured to receive wastewater from the second shaft structure 14b. The third shaft structure 14c has first and second portions (e.g., passages) 16c and 18c, respectively, that are separated by a divider 23c, such as a baffle wall. Furthermore, each portion 16c, 18c has an upper end 20c and a lower end 22c, and the lower ends 22c are interconnected.

Each shaft structure 14a, 14b and 14c may also be provided with a cover so that the shaft structures have closed tops. The covers are not shown in FIG. 1 in order to show features of each shaft structure 14a, 14b and 14c.

Each shaft structure 14a, 14b, 14c may have any configuration suitable for a particular application. In the embodiment shown in FIGS. 1-3, the shaft structures 14a, 14b and 14c are disposed substantially or entirely below ground, are connected directly together, and are oriented generally vertically. For example, the shaft structures 14a, 14b and 14c and corresponding portions or passages may each have a longitudinal axis that is coincident with a vertical line or that extends at an angle (e.g., 10° or less) with respect to a vertical line. Furthermore, in the embodiment shown in FIGS. 1-3, the first and second shaft structures 14a and 14b, respectively, each have a generally circular horizontal cross-section having a hydraulic diameter in the range of 10 to 200 feet, and the third shaft structure 14c has a generally semi-circular horizontal cross-section having a radius in the range of 5 to 100 feet (although the third shaft structure may instead have a generally circular horizontal cross-section section having a hydraulic diameter in the range of 10 to 200 feet). As another example, each shaft structure 14a, 14b, 14c may have a cross-section that generally defines any suitable shape, such as a hexagon, octagon, ellipse, rectangle, or portion of any such shapes, and that has any suitable hydraulic diameter, such as a hydraulic diameter in the range of 5 to 200 feet. In addition, each shaft structure 14a, 14b, 14c may have any suitable length, such as a generally vertical length in the range of 10 to 200 feet. In addition, the shaft structures 14a, 14b, 14c may be made of any suitable material, such as concrete or steel, and may be constructed in any suitable manner (e.g., sinking caisson, tangent pile, slurry wall, or other construction method). For example, the shaft structures may be formed together as a common structure such that the first and second shaft structures 14a, 14b share a common wall and the second and third shaft structures 14b, 14c share a common wall. As another example, the shaft structures may be formed separately such that the shaft structures are spaced away from each other and connected together by connector passages that each have a length in the range of 1 to 10 feet, for example. In one such embodiment, each shaft structure 14a, 14b, 14c may be formed from a plurality of concrete rings that are stacked on top of each other in a sealing relationship.

In another embodiment, the shaft structures 14a, 14b and 14c may be disposed above ground or partially below ground. For example, about 20% to 75% of each shaft structure 14a, 14b and 14c may be disposed below ground.

Likewise, each divider 23a, 23b and 23c may have any suitable configuration for separating portions of the corresponding shaft structure 14a, 14b, 14c. For example, each divider 23a, 23b, 23c may have a generally straight configuration and extend generally vertically, or have at least a portion that is inclined. Furthermore, each divider 23a, 23b, 23c may terminate above a bottom of the corresponding shaft structure 14a, 14b, 14c, or may have an opening proximate the bottom of corresponding shaft structure 14a, 14b, 14c.

In the embodiment shown in FIGS. 1-3, the dividers 23a and 23c are vertical, and each extends from a top of the corresponding shaft structure to a location proximate the bottom of the corresponding shaft structure to allow wastewater to pass from the first portion 16a or 16c to the second portion 18a or 18c of the shaft structure. The divider 23b of the second shaft structure 14b, on the other hand, is inclined with respect to a vertical axis (e.g., extends at an angle in the range of 10° to 40° with respect to a vertical axis), but is still spaced away from a bottom of the second shaft structure 14b to allow wastewater to pass from the first portion 16b to the second portion 18b of the second shaft structure 14b.

In the embodiment shown in FIGS. 1-3, each divider 23a, 23b, 23c is connected to an exterior wall of the corresponding shaft structure. Each shaft structure 14a, 14b, 14c may also include one or more supports (e.g., baffle walls) for supporting the corresponding divider 23a, 23b, 23c.

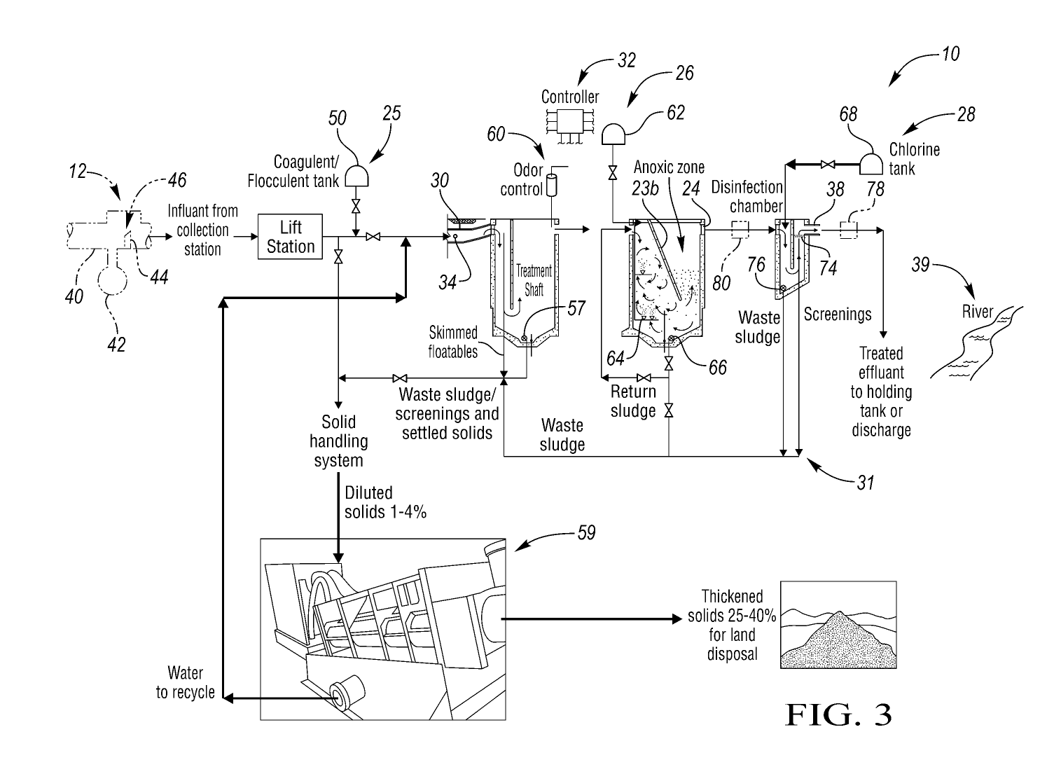

Referring to FIGS. 2 and 3, the system 10 may further include one or more of the following: a first treating agent introduction system 25 (e.g., a first dispenser) for introducing a first treating agent (e.g., a coagulation agent (coagulant) and/or flocculation agent (flocculent)) into the wastewater, a second treating agent introduction system 26 (e.g., a second dispenser) for introducing a second treating agent (e.g., a biological activity facilitating agent, such as a gaseous agent) into the wastewater, and a third treating agent introduction system 28 (e.g., a third dispenser) for introducing a third treating agent (e.g., a disinfection agent) into the wastewater. The treating agent introduction systems 25, 26 and 28 may include suitable piping, valves and/or controls for introducing the above agents into the wastewater. Furthermore, each treating agent introduction system 25, 26 and 28 may also include one or more mixers disposed at or near the point of introduction (e.g., injection) for mixing the corresponding treating agent with the wastewater. Each mixer may include, for example, a bubbler and/or a mechanical mixer.

The first treating agent introduction system 25 may operate to introduce the first treating agent into the wastewater at any suitable location to facilitate coagulation or clumping together of material, e.g, suspended solids, in the wastewater. In the embodiment shown in FIGS. 2 and 3, for example, the first treating agent introduction system 25 is operable to introduce the first treating agent into an influent passage 30 upstream of the first shaft structure 14a. In addition, or as an alternative, the first treating agent introduction system 25 may operate to introduce the first treating agent into the first shaft structure 14a. As another example, the first treating agent introduction system 25 may operate to introduce the first treating agent into the second shaft structure 14b and/or upstream of the second shaft structure 14b (e.g., between the first and second shaft structures 14a and 14b, in the first shaft structure 14a, and/or in the influent passage 30).

The first treating agent may comprise any suitable agent or agents (e.g., chemicals), such as metal salts (e.g., iron and/or aluminum salts) and/or polymers (e.g., in the form of organic polyelectrolytes), that facilitate coagulation or clumping together of material. The first treating agent may therefore provide chemically enhanced primary treatment of the wastewater. As a more specific example, the first treating agent may comprise aluminum sulfate salt, otherwise known as alum, and a polymer. When injected, dosed or otherwise introduced into wastewater, the first treating agent may cause suspended solids to coagulate or otherwise clump together and form larger and/or denser particles, which may be efficiently removed by suitable screens and/or through settling in the treatment system 10. As a result, total suspended solids may be significantly reduced by the treatment system 10. For example, total suspended solids may be reduced by 30% to 60%.

Furthermore, part of the organic material in the wastewater may be in colloidal form, which does not settle or is not capable of being effectively trapped by screens. By addition of the first treating agent, however, the colloidal material may tend to flocculate, and the flocculated material may then settle and/or be removed by suitable screens in the treatment system 10. As a result, the quantity of organic material in the wastewater may be reduced, which thereby reduces biological oxygen demand (BOD) levels. For example, BOD levels in the wastewater may be reduced from 400 to 500 milligrams per liter (mg/L) to less than 200 mg/L after treatment with the first treating agent (e.g., after exiting the first shaft structure 14a).

The second treating agent introduction system 26 may operate to introduce the biological activity facilitating agent (e.g., a gas, such as air or oxygen) into the wastewater at any suitable location to facilitate biological treatment of the wastewater to thereby further reduce organic material. In the embodiment shown in FIGS. 2 and 3, for example, the second treating agent introduction system 26 is operable to introduce the biological activity facilitating agent into the second shaft structure 14b, so that the biological activity facilitating agent enhances activity (e.g., aerobic activity) of the activated sludge or other biological media (e.g., media comprising microorganisms). In addition, or as an alternative, the second treating agent introduction system 26 may operate to introduce the biological activity facilitating agent into the first shaft structure 14a and/or between the first and second shaft structures 14a and 14b.

Likewise, the third treating agent introduction system 28 may operate to inject or otherwise introduce the disinfection agent into the wastewater at any suitable location, such that the disinfection agent has sufficient contact time with the wastewater to at least partially disinfect the wastewater. In the embodiment shown in FIGS. 2 and 3, for example, the third treating agent introduction system 28 is operable to introduce the disinfection agent into the third shaft structure 14c and/or upstream of the third shaft structure 14c, such that the disinfection agent is introduced into the wastewater after sufficient biological treatment of the wastewater.

The disinfection agent may be any suitable disinfection agent, such as peracetic acid, chlorine or a solution that includes peracetic acid and/or chlorine. As a more specific example, the disinfection agent may be a sodium hypochlorite disinfection solution. As another example, the disinfection may comprise ozone that is produced on site (e.g., at the location of the treatment system 10) from air and electricity or light (e.g., ultraviolet light).

The treatment system 10 may also include a removal system 31 (e.g., solids processing unit or system) for removing solid waste material from the shaft structures 14a, 14b and 14c, as well as activated sludge or other biological media from the second shaft structure 14b. As explained below, the removal system 31 may also function to recirculate a portion of the removed activated sludge or other biological media to the second shaft structure 14b to control biomass concentration (e.g., maintain desired concentration of microorganisms) in the second shaft structure 14b. The removal system 31 may include suitable piping, valves and/or controls for performing the above functions.

In addition, the treatment system 10 may include a control system, such as a computer control system or controller 32, for controlling operation of the treating agent introduction systems 25, 26 and 28, the removal system 31 and/or any other components of the system 10. The controller 32 shown in FIG. 3 is in communication (e.g, wired connection or wireless connection) with the treating agent introduction systems 25, 26 and 28 for controlling introduction of the treating agents, and the removal system 31 for controlling removal and/or recirculation of material. The controller 32 may also be in communication with one or more sensors, such as one or more flow sensors 34 disposed in the influent passage 30 and/or one or more of the shaft structures 14a, 14b and 14c, and one or more fluid level sensors disposed at various locations of the treatment system 10 and/or sewer 12 (e.g., positioned at the bottom of the shaft structures 14a, 14b and 14c, in the influent passage 30, and/or in a line of the sewer 12). While the controller 32 may be disposed in any suitable position, in the embodiment shown in FIG. 3, the controller 32 is disposed proximate the shaft structures 14a, 14b and 14c.

In addition, the treatment system 10 may include an effluent passage 38 in communication with one or more of the shaft structures 14a, 14b and 14c for discharging treated wastewater from the treatment system 10 to a river 39 or any other suitable area, such as another receiving water body, collection area, tank for future reuse, etc. In the embodiment shown in FIGS. 1-3, the effluent passage 38 is in fluid communication with the second portion 18c of the third shaft structure 14c.

Referring to FIGS. 1-5, operation of the treatment system 10 will now be described in detail. If the sewer system 12 is configured as a sanitary sewer system, or a combined sewer system that is designed to carry both sanitary sewage and storm water runoff, then the treatment system 10 may function as a main treatment plant for continuously or intermittently treating wastewater. On the other hand, the treatment system 10 may function as a treatment system for treating excess wastewater (e.g., excess wastewater generated during a sufficient rain event that exceeds capacity of a main treatment plant) from the sewer system 12 if, for example, the sewer system 12 is configured as a combined sewer system. In such a case, under normal operating conditions, such as during dry weather conditions, wastewater may flow through trunk sewer 40 (shown in phantom lines in FIG. 3) of the sewer system 12 and into an interceptor 42 (shown in phantom lines in FIG. 3), which carries wastewater to a treatment facility, such as a main wastewater treatment plant (not shown). During a sufficient rain event, flow from the trunk sewer 40 will exceed capacity of the interceptor 42, and excess wastewater will flow into influent passage 30. For example, excess wastewater may flow over a weir 44 in diversion chamber 46 and into influent passage 30. Advantageously, the treatment system 10 may be configured to handle a relatively large flow rate, such as a flow rate in the range of 2,000 to 1,500,000 gallons per minute.

Once wastewater is received in the influent passage 30, whether from a sanitary sewer system or a combined sewer system, the wastewater may then flow through a screen (e.g., fixed bar screen or rake screen) to remove relatively large debris. The wastewater may then flow into the first shaft structure 14a, and then into the other shaft structures 14b and 14c. Each shaft structure 14a, 14b, 14c is configured to allow the wastewater to flow through the corresponding first and second portions such that the wastewater is able to flow generally in a first direction through the corresponding first portion, then generally in a second direction different than the first direction through the corresponding second portion. For example, wastewater may flow generally downward in each first portion of each shaft structure 14a, 14b, 14c, and generally upward in each second portion of each shaft structure 14a, 14b, 14c. With such a configuration, each shaft structure 14a, 14b, 14c may enable generally U-shaped flow therethrough.

As mentioned above, in the embodiment shown in FIGS. 1-3, the first shaft structure 14a is configured for suspended solids removal, and may also achieve considerable organic material removal as well; the second shaft structure 14b is configured for biological treatment and secondary clarification; and the third shaft structure 14c is configured for disinfection. With such a configuration, the first treating agent introduction system 25 may operate to introduce the first treating agent upstream of the first shaft structure 14a (e.g., in the influent passage 30) and/or in the first shaft structure 14a, the second treating agent introduction system 26 may operate to introduce the second treating agent in the second shaft structure 14b, and the third treating agent introduction system 28 may operate to introduce the third treating agent in the third shaft structure 14c and/or upstream of the third shaft structure 14c.

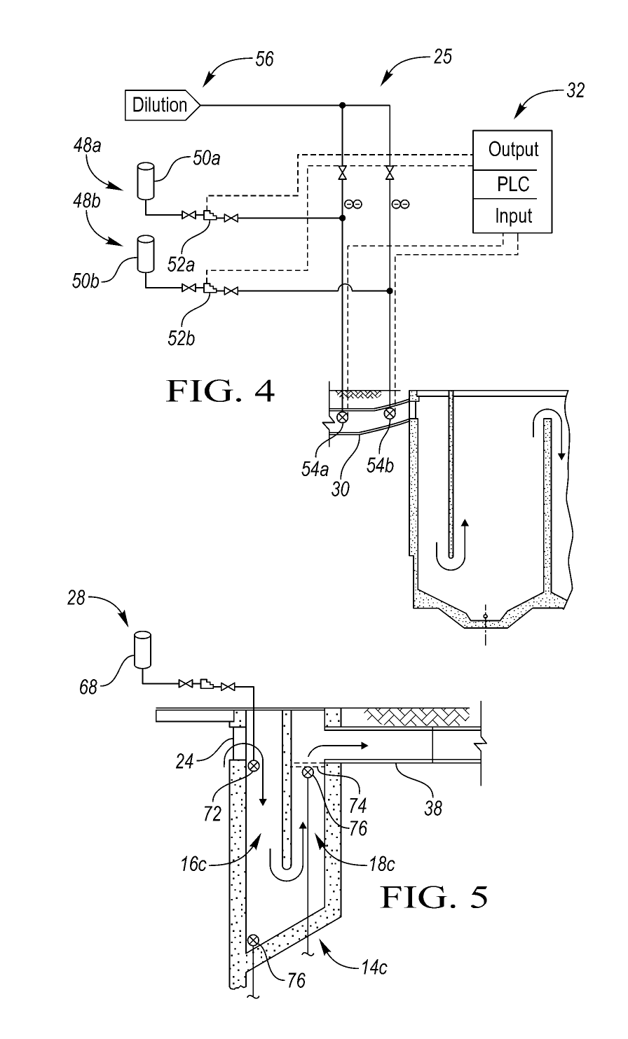

Referring to the embodiment shown in FIG. 4, the first treating agent introduction system 25 may include a primary coagulant and/or flocculant injection subsystem 48a and a polymer injection subsystem 48b. Each subsystem 48a and 48b may include, for example, a storage tank 50a, 50b for storing the respective first treating agent (e.g., coagulant, flocculant, or polymer), suitable piping and controllable valves for facilitating injection or other introduction of the respective first treating agent into the influent passage 30 or other component of the treatment system 10, a flow meter 52a, 52b for monitoring or measuring dosage amount of the respective first treating agent and one or more mixers 54a, 54b for facilitating mixing of the respective first treating agent with the wastewater. The first treating agent introduction system 25 may also include a dilution subsystem or device 56 for diluting each first treating agent prior to introduction into the influent passage 30. Based on information provided by the flow meters 52a and 52b, the controller 32 may control the valves to provide necessary dosages of the first treating agents to achieve desired results.

As mentioned above, the first treating agent may facilitate coagulation or clumping together of material, e.g., suspended solids (which may include organic material), in the wastewater, such that the material forms larger and/or denser particles (eg., floc), which may be efficiently removed by suitable screens or screen arrangements (not shown) positioned in the first shaft structure and/or through settling in the treatment system 10. Referring to FIG. 3, for example, settled material may be removed from the bottom of the first shaft structure 14a, such as by a pump 57 of the removal system 31. Wastewater may be separated from the removed solid material, such as by a separator 59 (e.g., solids separator) of the removal system 31, and returned to the influent passage 30 or first shaft structure 14a, while the solid material may be collected for subsequent disposal or further treatment. The separator 59 may comprise any suitable device or devices, such as a Volute dewatering press and/or Volute sludge thickener manufactured by Process Water Technologies of Rosedale, Md.

As also shown in FIG. 3, the treatment system 10 may include an odor control system 60 for controlling the odor of the wastewater. For example, the odor control system 60 may be operable to remove air from the headspace of the first shaft structure 14a and/or other shaft structures 14b and 14c, such as by a vacuum pressure, route the air through a suitable filter, such as an activated carbon filter, to remove odor and then release the air to the atmosphere. Alternatively or in addition, the odor control system 60 may be operable to introduce an odor control agent, such as chlorine or a solution that includes chlorine, into the wastewater in the first shaft structure 14a and/or upstream of the first shaft structure 14a, such as in the influent passage 30. The dosage amount of the odor control agent is selected so as to sufficiently kill bacteria in order to control odor, while not significantly adversely affecting biological treatment downstream of the first shaft structure 14a.

After the wastewater flows through the first and second portions 16a and 18a respectively, of the first shaft structure 14a, the wastewater may then flow into the first portion 16b of the second shaft structure 14b, where the wastewater mixes with the activated sludge to form a mixture referred to as mixed liquor. In the embodiment shown in FIG. 3, the second treating agent introduction system 26 is operable to introduce the second treating agent into the first portion 16b of the second shaft structure 14b to facilitate aerobic biological activity (e.g., aerobic treatment) in the first portion 16b. For example, the second treating agent introduction system 26 may include a source of gas, such as an air compressor or on-site oxygen generator and a tank 62 that stores compressed air or oxygen, and one or more dispensing units 64, such as diffusers, nozzles, aerators, bubblers, or mixers, in fluid communication with the tank 62 and disposed at varying heights in the first portion 16b of the second shaft structure 14b for introducing the gas into the wastewater to thereby increase dissolved oxygen levels in the mixed liquor. The second treating agent introduction system 26 may be configured to introduce the second treating agent at any suitable pressure, such as a pressure sufficient to overcome static water pressure.

As mentioned above, the second treating agent facilitates aerobic biological activity in the first portion 16b of second shaft structure 14b. For example, the second treating agent may enhance or otherwise facilitate consumption or decomposition of organic material by microorganisms in the activated sludge or other biological media. As a result, BOD levels may be significantly reduced. For example, BOD levels in the wastewater may be reduced to levels at or below 5 to 10 mg/L upon exiting the second shaft structure 14b.

The dispensing units 64 and divider 23b in the second shaft structure 14b may facilitate interaction of the activated sludge, second treating agent (e.g., compressed air or oxygen) and wastewater. For example, the dispensing units 64 and divider 23b may be configured to facilitate mixing of the activated sludge_(and/or other biological media), second treating agent and wastewater in the first portion 16b of the second shaft structure 14b. More specifically, multiple dispensing units 64 positioned at varying heights may cooperate with the angled divider 23b to facilitate mixing of the activated sludge, second treating agent and wastewater. The angled divider 23b may also function to confine the second treating agent on the left side (aerated or aerobic zone) of the divider 23b so that upward movement of the second treating agent will oppose the downward flow of wastewater in the first portion 16b of the second shaft structure 14b, thereby increasing contact between the second treating agent and the wastewater and increasing oxygen transfer to the wastewater (e.g., dissolved oxygen).

The mixed liquor may then flow from the first portion 16b of the second shaft structure 14b and into the second portion 18b of the second shaft structure, where it is not subjected to introduction of the second treating agent. As a result, anaerobic and/or anoxic biological treatment may then occur in the second portion 18b of the second shaft structure 14b (the divider 23b separates the anoxic zone to the right of the divider 23b from the aerated zone to the left). In that regard, anaerobic and anoxic treatment processes are characterized by the absence of free oxygen from the treatment process, and do not require the input of oxygen. Such treatment may result in further biodegradation of organic material, as well as the removal of nitrogen and/or nitrates from the wastewater, as explained below in further detail. Furthermore, since the mixed liquor in the second portion 18b of the second shaft structure 14b is not subjected to mixing caused by introduction of the second treating agent, the activated sludge may separate from the wastewater.

Activated sludge that collects at the bottom of the second shaft structure 14b may be removed from the bottom of the second shaft structure 14b, such as by a pump 66 of the removal system 31. Some or all of the activated sludge may be returned to the upper end of the first portion 16b of the second shaft structure 14b (e.g., recycled or returned activated sludge), so that the returned sludge may move downwardly due to gravity and mix again with the mixed liquor. Removed waste sludge and wastewater, on the other hand, may be routed to the separator 59. The wastewater may be separated from the removed waste sludge, such as by the separator 59, and returned to the influent passage 30 or first shaft structure 14a, while the solid material may be collected for subsequent disposal or further treatment.

After the wastewater flows through the first and second portions 16b and 18b respectively, of the second shaft structure 14b, the wastewater may then flow through the membrane 24 and into the first portion 16c of the third shaft structure 14c. In the embodiment shown in FIGS. 3 and 5, the third treating agent introduction system 28 is operable to introduce the third treating agent into the first portion 16c of the third shaft structure 14c and/or upstream of the first portion 16c to at least partially disinfect the wastewater after sufficient biological treatment. For example, the third treating agent introduction system 28 may introduce the third treating agent proximate the membrane 24 or between the second and third shaft structures 14b and 14c if, for example, the treatment system 10 is provided without the membrane 24 between the second and third shaft structures 14b and 14c. In the embodiment shown in FIG. 5, the third treating agent introduction system 28 includes a storage tank 68 for storing the third treating agent, and one or more mixers 72 for facilitating mixing of the third treating agent with the wastewater after the wastewater passes through the membrane 24. If the third treating agent includes ozone produced on site, then the ozone may be injected or otherwise introduced into the wastewater using any suitable dispensing units, such as bubble diffusers, venturi injectors, etc., positioned in the first portion 16c of the third shaft structure, for example.

The treatment system 10 may be configured to enable sufficient contact time to occur between the third treating agent and the wastewater as the wastewater continuously flows from the point of injection or other introduction of the third treating agent to the point of discharge from the effluent passage 38, so as to achieve sufficient disinfection, e.g., bacteria kill, of the wastewater at the point of discharge. Sufficient disinfection may be achieved, for example, when the mean fecal coliform bacteria level is less than 400 counts per 100 milliliters of wastewater, or other suitable level.

If the third treating agent comprises chlorine, the treatment system 10 may also be configured to provide dechlorination of the wastewater before discharging the wastewater. For example, the treatment system 10 may include a dechlorinating agent dispenser, such as a dechlorinating agent injection system (not shown), for introducing a dechlorinating agent, such as sulfur dioxide or sulfite salts (e.g., sodium sulfite, sodium bisulfite, or sodium metabisulfite), into the effluent passage 38. The dechlorinating agent injection system may be controlled by the controller 32, or by other suitable means, so that the dechlorinating agent will be introduced at a suitable point. Because dechlorination does not require much, if any, contact time, the dechlorinating agent may be introduced into the effluent passage 38 proximate to the discharge point of the effluent passage 38.

Referring to FIGS. 3 and 5, the treatment system 10 may further include one or more screens, such as a horizontal screen arrangement 74 positioned in the second portion 18c of the third shaft structure 14c and including one or more self-cleaning screens (e.g., raked bar screens), for screening the wastewater prior to discharge to effluent passage 38. Additional details of such a screen arrangement are disclosed in U.S. Pat. No. 8,021,543, which is hereby incorporated in its entirety by reference. As another example, the treatment system 10 may include one or more inclined screens.

Material trapped by the screens as well as solid material that settles in the bottom of third shaft structure 14c may be removed by the removal system 31, e.g., by one or more pumps 76. Referring to FIG. 3, wastewater may be separated from the removed solid material, such as by the separator 59, and returned to the influent passage 30 or first shaft structure 14a, while the solid material may be collected for subsequent disposal or further treatment.

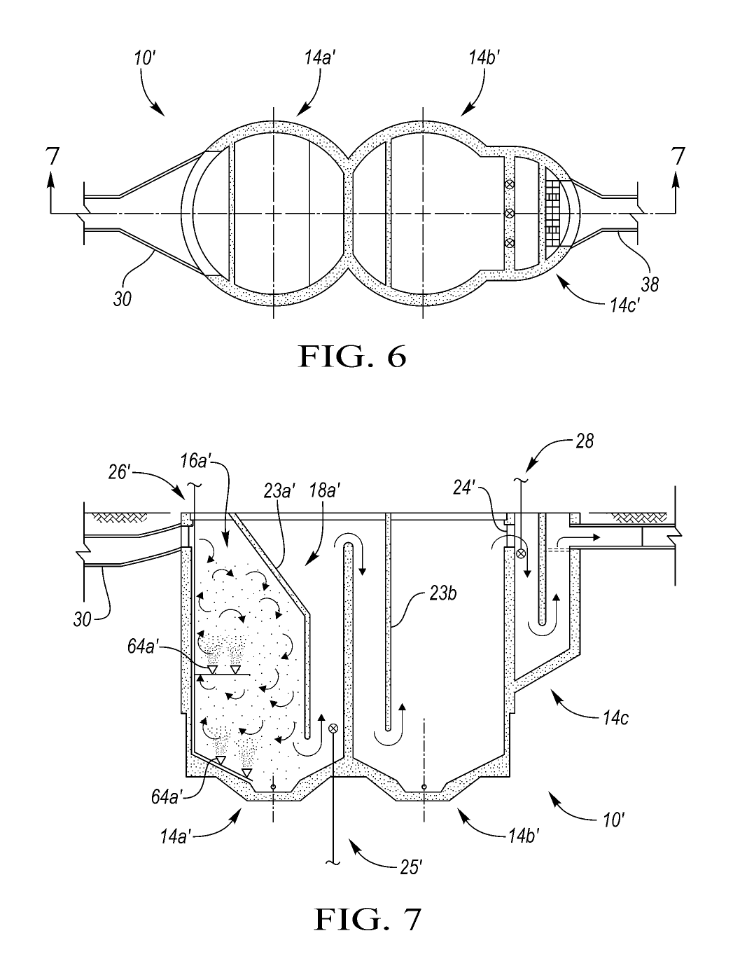

Additional embodiments 10′ and 10″ of the treatment system are shown in FIGS. 6-9. Features of the treatment systems 10′ and 10″ that are similar to features of the treatment system 10 are identified with similar reference numbers, except that some of the reference numbers of the treatment system 10′ may include a prime mark, and some of the reference numbers of the treatment system 10″ may include a double prime mark. Furthermore, various components of the treatment systems 10, 10′ and 10″ may function in a similar manner, such that a detailed description of all the components of the treatment systems 10′ and 10″ is not necessary.

In the treatment system 10′ shown in FIGS. 6 and 7, the biological treatment occurs in the first and second portions 16a′ and 18a ‘ of the first shaft structure 14a’, while the introduction of the first treating agent may occur in the second portion 18a′ of the first shaft structure 14a′ and/or elsewhere in the treatment system 10. Specifically, dispensing units 64′ of the second treating agent introduction system 26′ extend into the first portion 16a′ of the first shaft structure 14a′, and are operable to introduce the second treating agent (e.g., air or oxygen) at varying heights and lateral locations within the first portion 16a′ so that the second treating agent may facilitate aerobic biological treatment of the wastewater. To expedite the process of bacteria growth, activated sludge or other biological media (e.g., fixed media) comprising activated microorganisms may be positioned in the first portion 16a′.

The first shaft structure 14a′ may further include a divider 23a′, such as a baffle wall, that separates the first and second portions 16a′ and 18a′, respectively, of the first shaft structure 14a′, and that has at least a portion that is inclined to facilitate aerobic biological treatment in the first portion 16a′. In the embodiment shown in FIG. 7, the divider 23a′ includes a vertically oriented lower portion, and an inclined upper portion that is attached to the lower portion. The upper portion of the divider 23a′ may be inclined at an angle in the range of 15° to 60° with respect to a vertical axis, for example, and may function to facilitate mixing of the wastewater, activated sludge (and/or other biological media) and second treating agent, and/or increase contact between the second treating agent and the wastewater and/or activated sludge, as explained above in detail.

Anaerobic or anoxic biological treatment may then occur in the second portion 18a′ of the first shaft structure, and/or downstream of the first shaft structure 14a′. As explained above, such treatment may result in biodegradation of organic material, as well as the removal of nitrogen and/or nitrates from the wastewater. The process of biological nitrogen removal, known as denitrification, requires that the nitrogen be first converted to nitrates, which may occur in an aerobic treatment process such as in the first portion 16a′ of the first shaft structure 14a′. The nitrified wastewater is then exposed to an environment without free oxygen in the second portion 18a′ of the first shaft structure. Organisms in this anoxic system use the nitrate as an electron acceptor and release nitrogen in the form of nitrogen gas or nitrogen oxides. A readily biodegradable carbon source may also be needed for efficient denitrification processes to occur.

As mentioned above, introduction of the first treating agent may occur in the second portion 18a′ of the first shaft structure 14a′ and/or elsewhere in the treatment system 10′, such as upstream of the second portion 18a′ and/or in the second shaft structure 14b′. In the embodiment shown in FIG. 7, for example, the first treating agent introduction system 25′ is operable to introduce the first treating agent (e.g., coagulant and/or flocculent) near the lower end of the second portion 18a′ of the first shaft structure 14a′.

The treatment system 10′ may also include a membrane 24′ that is positioned downstream of the first shaft structure 14a′, such as between the second and third shaft structures 14b′ and 14c′, respectively. Like the membrane 24 mentioned above, the membrane 24′ is configured to allow wastewater to pass therethrough, while inhibiting or preventing passage of the activated sludge or other biological media. In addition, or as an alternative, the treatment system 10′ may include a membrane (not shown) that is positioned between the first and second shaft structures 14a′ and 14b′, respectively.

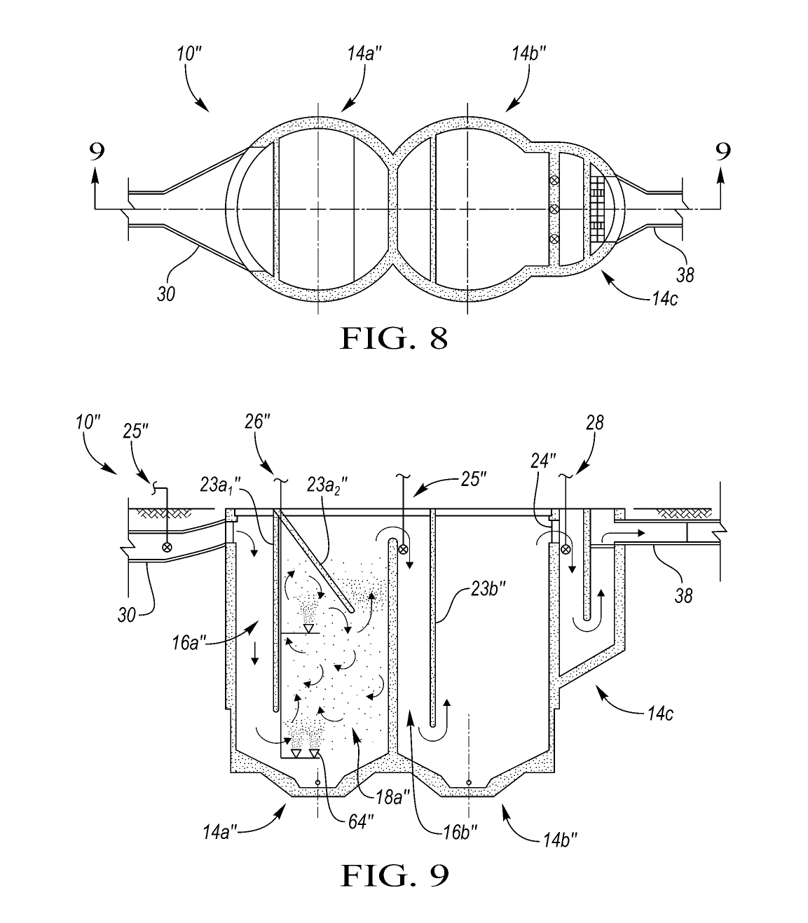

In the treatment system 10″ shown in FIGS. 8 and 9, the biological treatment occurs in the second portion 18a″ of the first shaft structure 14a″, while the introduction of the first treating agent may occur at any suitable location or locations in the treatment system 10″. Specifically, dispensing units 64″ of the second treating agent introduction system 26″ extend into the second portion 18a″ of the first shaft structure 14a″, and are operable to introduce the second treating agent (e.g., air or oxygen) at varying heights and lateral locations within the second portion 18a″ so that the second treating agent may facilitate aerobic biological treatment of the wastewater. To expedite the process of bacteria growth, activated sludge or other biological media (e.g., fixed media) containing activated microorganisms may be positioned in the second portion 18a″.

The first shaft structure 14a″ may further include a first divider 23a₁″, such as a vertical baffle wall, that separates the first and second portions 16a″ and 18a″, respectively, of the first shaft structure 14a″, and a second divider 23a₂″, such as a baffle wall, that extends into the second portion 18a″ for facilitating biological treatment in the second portion 18a″. In the embodiment shown in FIG. 9, the second divider 23a₂″ is connected to the first divider 23a₁″, and is inclined with respect to the first divider 23a₁″. For example, the second divider 23a₂″ may be inclined at an angle in the range of 15° to 60° with respect to the first divider 23a₁″ or a vertical axis, and may function to facilitate mixing of the wastewater, activated sludge (and/or other biological media) and second treating agent, and/or increase contact between the second treating agent and the wastewater and/or activated sludge, as explained above in detail.

Anaerobic or anoxic biological treatment may then occur proximate the upper end of the second portion 18a″ of the first shaft structure 14a″ (e.g., above the second divider 23a₂″) and/or downstream of the first shaft structure 14a″. Such treatment may result in biodegradation of organic material, as well as the removal of nitrogen and/or nitrates from the wastewater, as explained above in detail.

As mentioned above, introduction of the first treating agent may occur at any suitable location or locations in the treatment system 10″, such as upstream of and/or in the first portion 16a″ and/or in the second shaft structure 14b″. In the embodiment shown in FIG. 9, for example, the first treating agent introduction system 25″ is operable to introduce the first treating agent (e.g., coagulant and/or flocculent) in the influent passage 30 as well as into the second shaft structure 14b″.

The treatment system 10″ may also include a membrane 24″ that is positioned downstream of the first shaft structure 14a″, such as between the second and third shaft structures 14b″ and 14c″, respectively. Like the membrane 24 mentioned above, the membrane 24″ is configured to allow wastewater to pass therethrough, while inhibiting or preventing passage of the activated sludge or other biological media. In addition, or as an alternative, the treatment system 10″ may include a membrane (not shown) that is positioned between the first and second shaft structures 14a″ and 14b″, respectively.

The treatment systems 10′ and 10″ may each further include a third treating agent introduction system that is the same as or similar to the third treating agent introduction system 28 of the treatment system 10. Likewise, the treatment systems 10′ and 10″ may each further include a removal system (not shown) that is similar to the removal system 31 of the treatment system 10, except the removal system for each of the treatment systems 10′ and 10″ may be modified to remove and recirculate activated sludge or other biological media to the first shaft structure 14a′, 14a″ (first portion 16a′ for the treatment system 10′, and second portion 18a″ for the treatment system 10″).

In addition, each treatment system 10, 10′ and 10″ may include a biological media introduction system for introducing new or fresh biological media into the shaft structure (e.g., the first shaft structure or the second shaft structure) configured for biological treatment. Each biological media introduction system may be operated in conjunction with the corresponding removal system to achieve or maintain desired biomass concentration levels in the particular shaft structure. As another example, biological media may be introduced manually.

Each treatment system 10, 10′ and 10″ may also include an overflow container (not shown), such as a tunnel or an additional shaft structure, for receiving an initial quantity of wastewater from the sewer system 12 (e.g., first flush), or for receiving wastewater that exceeds capacity of the above described shaft structures. Additional details of such a container (e.g., tunnel) are disclosed in U.S. Pat. No. 6,503,404, which is hereby incorporated in its entirety by reference.

Furthermore, each treatment system 10, 10′ and 10″ may include an ultraviolet (UV) disinfection system in addition to, or as an alternative to, the third treating agent introduction system 28. For example, such a UV disinfection system may be connected in series with the third shaft structure 14c, 14c′, 14c″ (e.g., see UV disinfection system 78 shown schematically in phantom lines in FIG. 3), or may be used instead of the third shaft structure 14c, 14c′, 14c″ and corresponding third treating agent introduction system 28 and be connected in series with the second shaft structure 14b, 14b′, 14b″ (e.g., see UV disinfection system 80 shown schematically in phantom lines in FIG. 3).

An Ultraviolet (UV) disinfection system uses UV radiation or electromagnetic energy to disinfect wastewater (e.g., destroy or retard the ability of microorganisms to reproduce). Such a system may include, for example, suitable light or radiation sources (e.g., mercury arc lamps) and a reactor (e.g., contact type or non-contact type) for receiving the wastewater and exposing the wastewater to the UV radiation. Thus, the UV disinfection system may function as an alternative third treating agent introduction system or an additional third treating agent introduction system for introducing a disinfection agent (e.g., UV radiation or electromagnetic energy) into the wastewater. Additional details of a UV disinfection system are disclosed in U.S. Environmental Protection Agency paper EPA 832-F-99-064, published September 1999, which is hereby incorporated by reference. Embodiments according to the disclosure enable treated wastewater to meet higher levels of regulatory discharge limits beyond primary treatment. For example, embodiments according to the disclosure may provide: 1) increased total suspended solids and organic material removal as a result of adding coagulation and/or flocculation agents, and 2) reduced organic loading at discharge due to biological treatment of the wastewater.

With the treatment system 10, the second shaft structure functions as a biological treatment unit (e.g., aeration tank or unit) that provides biological treatment of the wastewater after primary clarification takes place in the first shaft structure. With the treatment systems 10′ and 10″, the corresponding first shaft structure functions as the biological treatment unit, while dual stage settling is provided in the corresponding first and second shaft structures.

It should be noted that a treatment system according to the disclosure may include any suitable number of shaft structures or other containers having a similar configuration as described above in detail. For example, a treatment system according to the disclosure may be provided with only two shaft structures, wherein primary settling and biological treatment may occur in a first one of the shaft structures, and disinfection may occur in a second one of the shaft structures. In another embodiment, a treatment system according to the disclosure may be provided with a single shaft structure, wherein primary settling, biological treatment and disinfection may all occur in the same shaft structure. In yet another embodiment, a treatment system according to the disclosure may include one or more shaft structures in which primary settling and biological treatment may occur, and a disinfection system (e.g., UV disinfection system) connected in series with the one or more shaft structures for providing disinfection of the wastewater.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A wastewater treatment system for treating wastewater, the wastewater treatment system comprising:
one or more containers that each include first and second portions, each portion having an upper end and a lower end, wherein, for each container, the corresponding lower ends are interconnected;
a first treating agent system for introducing a coagulation agent and/or flocculation agent into the wastewater;
a second treating agent system for introducing a biological activity facilitating agent into the wastewater; and
a third treating agent system for introducing a disinfection agent into the wastewater;
wherein each container is configured to allow the wastewater to flow through the corresponding first and second portions such that the wastewater is able to flow generally in a first direction through the corresponding first portion, then generally in a second direction different than the first direction through the corresponding second portion, and wherein the first treating agent system is operable to introduce the coagulation agent and/or flocculation agent into the wastewater to facilitate clumping of suspended particles, the second treating agent system is operable to introduce the biological activity facilitating agent into the wastewater to enhance biological treatment of the wastewater, and the third treating agent system is operable to introduce the disinfection agent such that the disinfection agent has sufficient contact time with the wastewater to at least partially disinfect the wastewater after sufficient biological treatment of the wastewater.

2. The wastewater treatment system of claim 1 wherein the one or more containers include first and second containers connected in series, the biological activity facilitating agent comprises a gas, and the second treating agent system is operable to introduce the gas into the first container.

3. The wastewater treatment system of claim 2 wherein the second treating agent system is operable to introduce the gas into the first portion of the first container.

4. The wastewater treatment system of claim 3 wherein the first container includes a baffle that separates the first and second portions of the first container, and the baffle has at least a portion that is inclined.

5. The wastewater treatment system of claim 2 wherein the second treating agent system is operable to introduce the gas into the second portion of the first container.

6. The wastewater treatment system of claim 5 wherein the first container includes a first baffle that separates the first and second portions of the first container, and a second baffle disposed in the second portion of the first container, and wherein the second baffle has at least a portion that is inclined.

7. The wastewater treatment system of claim 2 wherein the first treating agent system is operable to introduce the coagulation agent and/or flocculation agent upstream of the introduction of the gas.

8. The wastewater treatment system of claim 2 wherein the first treating agent system is operable to introduce the coagulation agent and/or flocculation agent downstream of the introduction of the gas.

9. The wastewater treatment system of claim 8 wherein the first treating agent system is operable to introduce the coagulation agent and/or flocculation agent into or upstream of the second container.

10. The wastewater treatment system of claim 1 wherein the one or more containers include first and second containers connected in series such that the second container is disposed downstream of the first container, the first treating agent system is operable to introduce the coagulation agent and/or flocculation agent into and/or upstream of the first container, the biological activity facilitating agent comprises a gas, and the second treating agent system is operable to introduce the gas into the second container.

11. The wastewater treatment system of claim 10 wherein the second container includes a baffle that separates the first and second portions of the second container, and the baffle has at least a portion that is inclined.

12. The wastewater treatment system of claim 1 wherein the one or more containers include first, second and third containers connected in series such that the second container is disposed downstream of the first container, and the third container is disposed downstream of the second container.

13. The wastewater treatment system of claim 12 wherein the first treating agent system is operable to introduce the coagulation agent and/or flocculation agent into and/or upstream of the first container, the biological activity facilitating agent comprises gas, the second treating agent system is operable to introduce the gas into the second container, and the third treating agent dispense is operable to introduce the disinfection agent into and/or upstream of the third container.

14. The wastewater treatment system of claim 13 wherein the second container includes a baffle that separates the first and second portions of the second container, and the baffle has at least a portion that is inclined.

15. A wastewater treatment system for treating wastewater from a sewer system, the wastewater treatment system comprising:
a vertically oriented first shaft configured to receive wastewater from the sewer system, the first shaft having first and second portions that each have an upper end and a lower end, the lower ends being interconnected;
a vertically oriented second shaft connected in series with the first shaft and configured to receive wastewater from the first shaft, the second shaft having first and second portions that each have an upper end and a lower end, the lower ends being interconnected;
a vertically oriented third shaft connected in series with the second shaft and configured to receive wastewater from the second shaft, the third shaft having first and second portions that each have an upper end and a lower end, the lower ends being interconnected;
a first treating agent system for introducing a coagulation agent and/or flocculation agent into the wastewater;
a second treating agent system for introducing a gas into the wastewater; and
a third treating agent system for introducing a disinfection agent into the wastewater;
wherein the system is configured to allow the wastewater to flow into the upper end of the first shaft first portion, through the first shaft first and second portions, then into the upper end of the second shaft first portion, through the second shaft first and second portions, then into the upper end of the third shaft first portion, and through the third shaft first and second portions, such that, for each of the first, second and third shaft, the wastewater is able to flow generally downward through the corresponding first portion, then generally upward through the corresponding second portion, and wherein the first treating agent system is operable to introduce the coagulation agent and/or flocculation agent into the wastewater to facilitate clumping of suspended particles, the second treating agent system is operable to introduce the gas into the wastewater in the first and/or second shaft to enhance biological treatment of the wastewater, and the third treating agent system is operable to introduce the disinfection agent such that the disinfection agent has sufficient contact time with the wastewater in the third shaft to at least partially disinfect the wastewater.

16. The wastewater treatment system of claim 15 wherein the second shaft is configured to receive biological media for the biological treatment of the wastewater, the first treating agent system is operable to introduce the coagulation agent and/or flocculation agent into and/or upstream of the first shaft, and the second treating agent system is operable to introduce the gas into the second shaft, and wherein the gas comprises oxygen.

17. The wastewater treatment system of claim 15 wherein the third treating agent dispense is operable to introduce the disinfection agent into and/or upstream of the third shaft.

18. The wastewater treatment system of claim 17 wherein the second shaft includes a baffle that separates the first and second portions of the second shaft, and the baffle has at least a portion that is inclined.

19. A method for treating wastewater from a sewer system, the method comprising:
receiving the wastewater from the sewer system in a first portion of a first container, wherein the first container further includes a second portion, each portion having an upper end and a lower end, the lower ends being interconnected;
allowing the wastewater to flow generally in a first direction through the first portion, and then generally in a second direction through the second portion, wherein the second direction is different than the first direction;
introducing a coagulation agent and/or flocculation agent into the wastewater to facilitate clumping of suspended particles;
introducing a biological activity facilitating agent into the wastewater to enhance biological treatment of the wastewater; and
introducing a disinfection agent into the wastewater such that the disinfection agent has sufficient contact time with the wastewater to at least partially disinfect the wastewater after sufficient biological treatment of the wastewater.

20. The method of claim 19 further comprising:
receiving the wastewater from the first container in a first portion of a second container, wherein the second container further includes a second portion, each portion of the second container having an upper end and a lower end, the lower ends of the second container being interconnected;
allowing the wastewater to flow generally in a first direction through the first portion of the second container, and then generally in a second direction through the second portion of the second container, wherein the second direction is different than the first direction;
receiving the wastewater from the second container in a first portion of a third container, wherein the third container further includes a second portion, each portion of the third container having an upper end and a lower end, the lower ends of the third container being interconnected; and
allowing the wastewater to flow generally in a first direction through the first portion of the third container, and then generally in a second direction through the second portion of the third container, wherein the second direction is different than the first direction;
wherein introducing the biological activity facilitating agent into the wastewater occurs in the first and/or second containers.
